(19) United States
(12) Patent Application Publication
(10) Pub. No.: US 2009/0162119 A1
(43) Pub. Date: Jun. 25, 2009

(54) METHOD FOR IMAGE TO PAPER (IOP) REGISTRATION: IMAGE ONE TO IMAGE TWO ERROR COMPENSATION

(75) Inventors: Saurabh Prabhat, Webster, NY (US); Barry P Mandel, Fairport, NY (US); Steven R Moore, Pittsford, NY (US); Marina L Tharayil, Rochester, NY (US)

Correspondence Address: PATENT DOCUMENTATION CENTER;XEROX CORPORATION, 100 CLINTON AVE SOUTH, MAILSTOP: XRX2-020, ROCHESTER, NY, 14644, US

(73) Assignee: XEROX CORPORATION, Norwalk, CT (US)

(21) Appl. No.: 11/960,806

(22) Filed: Dec. 20, 2007

(51) Int. Cl. G03G 13/00

(52) U.S. Cl. 399/395

(57) ABSTRACT

A method to reduce the misalignment between the image one and image two printed on the same or opposing side of the same sheet. The final error (skew, process and cross-Process) between the actual sheet orientation and the desired orientation during the transfer of an image while printing image one is measured and recorded. When the same sheet comes for printing image two, the error recorded during image one printing is retrieved and used to compensate the desired angular, process and cross-process registration of the sheet for image two printing so that the alignment of image one and image two is improved in comparison to systems that register the sheet without considering image one imaging errors.

### BACKGROUND

The present exemplary embodiments relate generally to duplex printing and overprinting, and more particularly to image to paper (IOP) registration of image one to image two error compensation. The present exemplary embodiments relate to media (e.g., document or paper) handling systems and systems for printing thereon and is especially applicable for a printing system comprising xerographic devices or other marking engines such as inkjet.

As conventional in the art, simplex printing includes printing or imaging only a single side of a page or sheet of media. However, duplex printing includes printing or imaging both sides of the page or sheet media. Overprinting means printing multiple images on the same side of the sheet. Both simplex and duplex printing are well known in the art of printers, copiers, facsimile devices and the like.

With duplex printing, the alignment of the images on the front and back side of the page is critical. For example, when a stack of pages is folded to make a booklet, the back side of page one will share a margin with the front side of page two. Thus, any misalignment of the front and back images will produce an undesirable visible step at the margin.

Conventional image alignment or registration technologies focus on making the registration or image placement for each side of a page correct so that the front and back images will align correctly. However, to achieve acceptable simplex registration so that the duplexed pages are also acceptably aligned is prohibitively complex and expensive.

In addition, increasing the consistency of the simplex registration to improve the duplex registration cannot compensate for small errors in paper size. Since the duplex process flips the page to image the second side, both edges of the page (relative to the media processing direction in the imaging device) are used for positioning the page in the printer. Thus, when transferring the image to the paper varies during transfer, the front and back side images will be shifted by the amount of the page alignment error. Although a paper alignment error may be small, such small errors in front to back image alignment are very visible.

As explained for duplex printing, the same is also true for overprinting when printing a second image on the same side of the page which already has an image.

### SUMMARY

Accordingly, an object of the present invention is to provide a method to reduce the misalignment between the image one and image two, printed either on the different sides of the same sheet or on the same side of the same sheet. The final error (skew, process and cross-process) between the actual sheet orientation and the desired orientation during the transfer of image one is measured and recorded. When the same sheet comes for imaging the second time either on the same side or on side two, the error recorded during image one printing is retrieved and used to compensate the desired angular, process and cross-process registration of the sheet for image two printing so that the alignment of image one and image two are improved in comparison to systems that register the sheet without considering image one imaging errors.

There is provided a method of aligning images in an image forming device wherein a sheet has first image formed on a first side thereof and second image formed on an opposing second or same side thereof, the method comprising: forming the first image on the first side of the sheet with the image forming device; sensing skew and cross process alignment of the sheet while in the state of receiving the first image along at least one sheet edge approximately parallel with the process direction and storing a first skew and cross process alignment value; sensing process alignment of the sheet while in the state for receiving the first image along at least one sheet edge approximately parallel with the cross process direction and storing a first process alignment value; these errors (skew, process and cross-process) becomes the new reference for image two; transporting the sheet into the image forming device for the second image; re-sensing the skew, process and cross-process error in the sheet orientation and evaluating them with respect to the new reference; and positioning the sheet using these skew, process and cross process alignment errors to adjust desired position and orientation of the sheet before forming the second image on the opposing or same side thereby substantially minimizing relative first image to second image mis-registration.

### BRIEF DESCRIPTION OF THE DRAWINGS

FIG. 1 shows a schematic view of a printing system illustrating selective architectural embodiments of the subject developments.

FIG. 2 is a plan view of the sheet registration device illustrating the method of operation thereof.

FIG. 3 is a plan view of the sheet at the point of entry to an image transfer zone.

### DETAILED DESCRIPTION

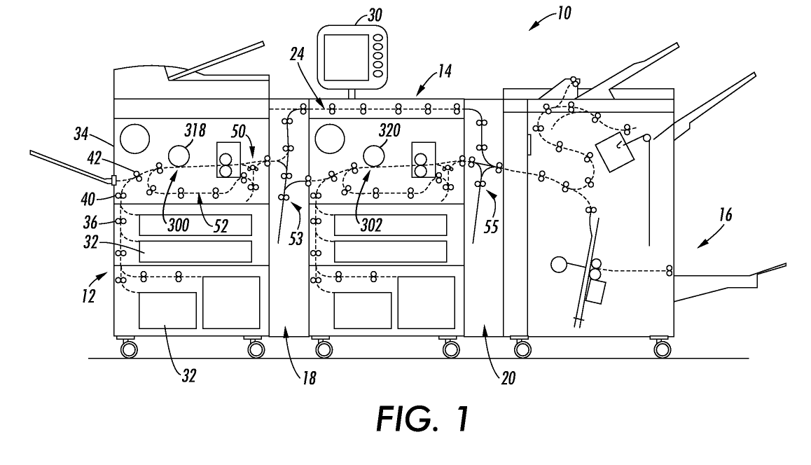

With reference to the drawings wherein the showings are for purposes of illustrating alternative embodiments and not for limiting same. FIG. 1 shows a schematic view of a printing system comprising a plurality of xerographic devices or marking engines associated for printing of documents within the system. More particularly, printing system 10 is illustrated as including primary elements comprising a first marking engine 12, a second marking engine 14 and a finisher assembly 16. Connecting these three elements are three transport assemblies 18, 24 and 20. The document outputs of the first marking engine 12 can be directed up and over the second marking engine 14 through horizontal by-pass path 24 and then to the finisher 16. Alternatively, where a document is to duplex printed or overprinted, the first marking engine 12 can output a document to vertical transport 18 which transports the document to the second marking engine 14 for duplex printing. The details of practicing parallel simplex printing and duplex printing through tandemly arranged marking engines are known and can be generally appreciated with reference to the foregoing cited U.S. Pat. No. 5,568,246. In order to maximize marking paper handling reliability and to simplify system jam clearance, the marking engines are often run in a simplex mode. The sheets exit the marking engine image-side up so they must be inverted before compiling in the finisher 16. Control station 30 allows an operator to selectively control the details of a desired print job.

The marking engines 12, 14 shown in FIG. 1 are conventional in this general illustration and include a plurality of document feeder trays 32 for holding different sizes of documents that can receive print markings by the marking engine portion 34. Marking engines 12 and 14 have marking elements 318 and 320 which are comprised of xerographic devices or other devices such as inkjet printheads. The image transfer zone 300 and 302 in each respective marking element can be considered to be that portion of the marking engine in which some portion of the sheet is in the process of having an image transferred to it. Each marking engine 12, 14 is shown to include an inverter assembly 50 conventionally known as useful for duplex printing of a document by the same engine. More particularly, after one side of a document is printed, it is transported to the inverter assembly 50 where it is inverted and then communicated back to the image transfer zone by duplex path 52.

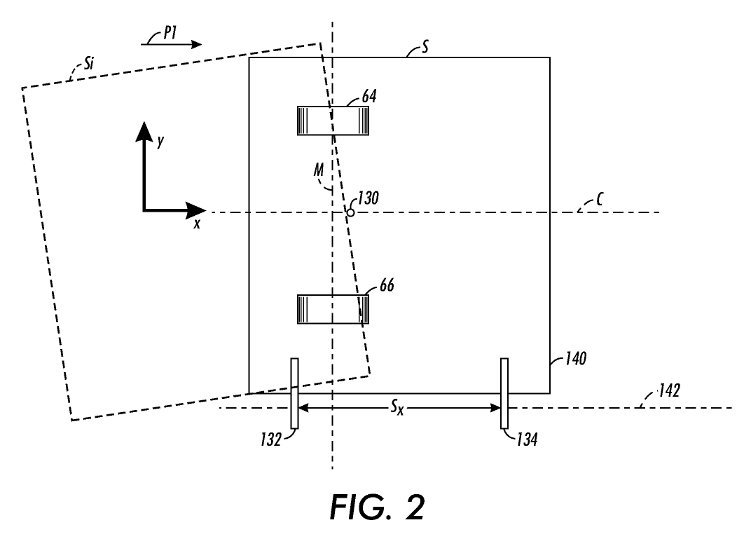

Referring to FIG. 2 prior to image transfer zone 34 each marking engine includes a device suitable for registering the document with respect to the image formation device. The device consists of independently driven pinch nips 64 and 66 and sensors as shown in the figure.

FIG. 2 illustrates a method for registration of a sheet of paper prior to delivery to the image transfer zone. Paper path P1 can be provided with a series of at least three sensors, 130, 132, 134. Sensor 130 is located along the paper path centerline C and is positioned slightly downstream of nip roll pair 64 and 66. Sensors 132 and 134 are located at positions where one side edge 140 of a paper sheet S will pass, for detection by the sensors. In one embodiment, sensor 132, may be located between 10 mm and 70 mm further away from a line M connecting nip roll pairs 64 and 66. In one working example, sensor 132 was spaced 40 mm upstream from line M. The spacing Sx between sensors 132 and 134 will be made as large as physically possible in order to accurately determine the sheet skew angle. It will be appreciated that what is necessary in the positioning of sensors 132 and 134 is that the position allows detection of the sheet side edge 140 subsequent to, or simultaneous with, skew detection, and accordingly, upstream or downstream positions are well within the scope of the exemplary embodiments. Nip 64 and nip 66 impose velocities V₁ and V₂ to the paper, thus steering the paper. Appropriate velocity profiles can register the paper at datum 142 with proper position and orientation with respect to the image formation device. Methods for selecting the profiles as well as methods for servo control of the nips to impose these profiles are now described.

FIG. 2 shows a sheet of paper Si as it is entering the registration nip from an upstream transport. Leading edge sensor 130 notifies a controller that a sheet has entered the nip and time stamps the arrival for process direction registration. Paper lateral position and orientation (skew) are determined from measurements provided by sensors 132 and 134. With this information, the media registration device controller can generate the velocity profiles for sheet registration at datum 142.

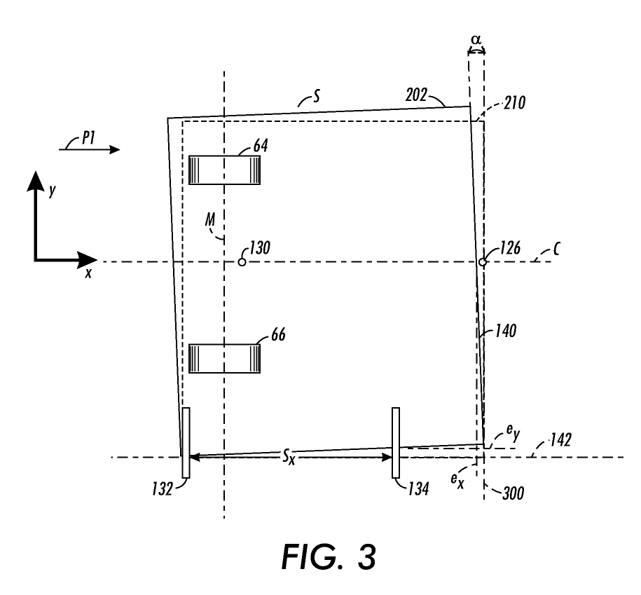

Referring to FIG. 3, as the sheet leading edge approaches image transfer zone 300 or 302 (as shown in FIG. 1) any final sheet position and orientation errors (α, ex and ey) between the actual sheet orientation 202 (as read from the sensor pair 132 and 134 and lead edge process sensor 126) and the desired orientation 210 at the time of transfer of an image is measured and recorded.

α is the angle between the orientation read by the sensor pair 132 and 134 and the desired orientation at the time of transfer.
ey is the error in Cross-Process alignment of the sheet at the CM as read by sensor pair 132 and 134.
ex is the error in Process alignment of the sheet at the CM as read by sheet lead edge process sensor 126.

When the same sheet comes for imaging image two, the errors (α, ex and ey) recorded during side one printing is retrieved and used by the media registration device controller to compensate the desired angular, process and cross-process orientation for image two so that the misalignment of image one and image two is improved in comparison to the systems that register the sheet without considering image one imaging errors.

Prior to reaching the transfer zone for printing the second image which could be with the marking engine 12 or in marking engine 14, sheet is re-registered with media registration device controller in a similar manner as discussed supra in regard to image one. However, media registration device controller uses the skew, process and cross-process alignment errors in image one to adjust desired position and orientation of the sheet before forming the second image thereby substantially minimizing relative first image to second image mis-registration.

In one embodiment in combination with media registration device controller reregistering the sheet, media registration device controller can also send the skew correction factor and the process and cross-process alignment correction factor to the image controller so that second image alignment is altered during formation of the image produced by marking element 318 or 320.

It is to be appreciated that a control system suitable for use in the exemplary embodiments is used in conjunction with the drive motors and sensors. A controller controls operations of the reproduction machine, or a portion thereof, as is well known in the art of reproduction machine control, and may be comprised of a microprocessor capable of executing control instruction in accordance with a predetermined sequence, and subject to sensed parameters, and producing a controlling output in response thereto. For the exemplary embodiments, an 8-bit microcontroller is a satisfactory microprocessor for control of, for example, a sheet registration subsystem of a reproduction machine. Other alternatives are, of course, available.

The exemplary embodiments have been described with reference to the specific embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

It will be appreciated that variants of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A method of aligning images in an image forming device wherein a sheet has first image formed on a first side thereof and second image formed on an opposing second side thereof, the method comprising:
forming the first image on the first side of the sheet with the image forming device;
sensing skew and cross process alignment of the sheet while in the state for receiving the first image along at least one sheet edge approximately parallel with the process direction and storing a first skew and cross process alignment value;
sensing process alignment of the sheet while in the state for receiving the first image along at least one sheet edge approximately parallel with the cross process direction and storing a first process alignment value;
transporting the sheet into the image forming device for the second side;
re-sensing skew of the sheet with and storing a second skew value, prior to forming the second image on the opposing side of the sheet;
re-sensing process and cross process alignment of the sheet and storing a second process and cross process alignment value; prior to forming the second image on the opposing side of the sheet;
comparing said first skew value to said second skew value and generating a skew correction factor based on the difference between these two values
comparing said first process and cross process alignment value to said second process and cross process alignment value and generating a process and cross process alignment correction factor based on the difference between said two values;
positioning the sheet using the skew correction factor and the process and cross process alignment correction factor to adjust desired position and orientation of the sheet before forming the second image on the opposing side thereby substantially minimizing relative first image to second image mis-registration.

2. The method of claim 1 wherein sensing skew and sensing process and cross-process alignment occurs immediately before transferring of the first image to the sheet.

3. The method of claim 1 wherein sensing skew and sensing process and cross-process alignment occurs during transferring of the first image to the sheet.

4. The method of claim 1 wherein sensing skew and sensing process and cross-process alignment occurs immediately after transferring of the first image to the sheet.

5. The method of claim 1 wherein the image on the second side of the sheet is printed on a second image forming device as the image on the side 1.

6. The method of claim 1, further comprising providing said skew correction factor and said process and cross-process alignment correction factor to a controller of a sheet handling device.

7. The method of claim 6 wherein registering comprises simultaneously cross-process translating and skewing of the media.

8. The method of claim 7, further comprising optionally providing said skew correction factor and said process and cross-process alignment correction factor to a controller of said image forming device and altering the position of second image on the opposing side.

9. A method of aligning images in an image forming device wherein a sheet has first image formed on a first side thereof and second image formed on an opposing second side thereof, the method comprising:
forming the first image on the first side of the sheet with the image forming device;
sensing skew and cross-process alignment of the sheet while in the state for receiving the first image along at least one sheet edge approximately parallel with the process direction and storing a first skew and cross-process alignment value;
sensing process alignment of the sheet while in the state for receiving the first image along at least one sheet edge approximately parallel with the cross-process direction and storing a first process alignment value;
transporting the sheet into the image forming device for the second side;
re-sensing skew of the sheet with and storing a second skew value, prior to forming the second image on the opposing side of the sheet;
re-sensing process and cross-process alignment of the sheet and storing a second process and cross-process alignment value; prior to forming the second image on the opposing side of the sheet;
using the second skew value, process and cross-process alignment value to position the sheet;
providing the first skew, process and cross-process alignment value to a controller of said image forming device and altering the position and orientation of second image on the opposing side with said image forming device thereby substantially minimizing relative first image to second image mis-registration.

10. The method of claim 9 wherein sensing skew and sensing process and cross process alignment occurs immediately before transferring of the first image to the sheet.

11. The method of claim 9 wherein sensing skew and sensing process and cross process alignment occurs during transferring of the first image to the sheet.

12. The method of claim 9 wherein sensing skew and sensing process and cross process alignment occurs immediately after transferring of the first image to the sheet.

13. A method of aligning images in an image forming device wherein a sheet has first image formed on a first image forming device thereof and second image formed on the same side thereof, the method comprising:
forming the first image on the first side of the sheet with the image forming device;
sensing skew and cross-process alignment of the sheet while in the state for receiving the first image along at least one sheet edge approximately parallel with the process direction and storing a first skew and cross-process alignment value;
sensing process alignment of the sheet while in the state for receiving the first image along at least one sheet edge approximately parallel with the cross-process direction and storing a first process alignment value;
re-sensing skew of the sheet with and storing a second skew value, prior to forming the second image on the same side of the sheet;
re-sensing process and cross-process alignment of the sheet and storing a second process and cross-process alignment value; prior to forming the second image on the same side of the sheet;
comparing said first skew value to said second skew value and generating a skew correction factor based on the difference between these two values;
comparing said first process and cross-process alignment value to said second process and cross-process alignment value and generating a process and cross-process alignment correction factor based on the difference between said two values;
positioning the sheet using the skew correction factor and the process and cross-process alignment correction factor to adjust desired position and orientation of the sheet before forming the second image on the same side thereby substantially minimizing relative first image to second image mis-registration.

14. A method of aligning images in an image forming device wherein a sheet has first image formed on a first side thereof and second image formed on the same side thereof, the method comprising:
forming the first image on the first side of the sheet with the image forming device;
sensing skew and cross-process alignment of the sheet while in the state for receiving the first image along at least one sheet edge approximately parallel with the process direction and storing a first skew and cross-process alignment value;
sensing process alignment of the sheet while in the state for receiving the first image along at least one sheet edge approximately parallel with the cross-process direction and storing a first process alignment value;
re-sensing skew of the sheet with and storing a second skew value, prior to forming the second image on the same side of the sheet;
re-sensing process and cross-process alignment of the sheet and storing a second process and cross-process alignment value; prior to forming the second image on the same side of the sheet;
using the second skew value, process and cross-process alignment value to position the sheet;
providing the first skew, process and cross-process alignment value to a controller of said image forming device and altering the position and orientation of second image on the same side with said image forming device thereby substantially minimizing relative first image to second image mis-registration.

15. The method of claim 14 wherein sensing skew and sensing process and cross process alignment occurs immediately before transferring of the first image to the sheet.

16. The method of claim 14 wherein sensing skew and sensing process and cross process alignment occurs during transferring of the first image to the sheet.

17. The method of claim 14 wherein sensing skew and sensing process and cross process alignment occurs immediately after transferring of the first image to the sheet.
